(19) United States
(12) Patent Application Publication
(10) Pub. No.: US 2015/0067151 A1
(43) Pub. Date: Mar. 5, 2015

(54) SYSTEM AND METHOD FOR GATHERING AND DISPLAYING DATA IN AN ITEM COUNTING PROCESS

(71) Applicant: Output Technology, Incorporated, Plymouth, MN (US)

(72) Inventors: Steven G. Sands, Plymouth, MN (US); Joseph R. Lacher, Zimmerman, MN (US)

(21) Appl. No.: 14/461,872

(22) Filed: Aug. 18, 2014

Related U.S. Application Data
(60) Provisional application No. 61/874,065, filed on Sep. 5, 2013.

(51) Int. Cl. H04L 12/26; H04L 29/06

(52) U.S. Cl. CPC H04L 43/08; H04L 67/42
USPC 709/224

(57) ABSTRACT

Methods and systems for providing information about production lines in a process environments are provided. In one embodiment, a method for providing a notification of a production line status includes receiving a status indication of a production line from a tracker associated with the production line. The method further includes transmitting the status indication from the tracker to a server. Finally, the method includes transmitting the notification from the server to a client device, wherein the notification comprises the status indication.

### REFERENCE TO RELATED CASE

The present application claims the priority of U.S. provisional application Ser. No. 61/874,065, filed on Sep. 5, 2013, the content of which is hereby incorporated by reference in its entirety.

### BACKGROUND

Electronic item counters are employed in a wide variety of applications. Some examples include, but are not limited to, industrial and commercial applications that manufacture, extract, and/or process materials. Some particular applications can employ Lean Manufacturing and 5S (sorting, set in order, systematic cleaning, standardizing and sustaining) processes.

It is often important to provide production operators with real time feedback of progress against process goals and to provide the production operators input and control over notifying the upstream and downstream processes that affect their particular workstation. In addition, lean manufacturing and 5S processes can require a means to provide management with a clear and real time monitoring of production process performance.

Some systems utilize multiple dedicated function, fixed character link, and fixed height numerical segmented displays, along with independent and/or color tower lamps. Other systems utilize custom designed display boards or dedicated software programs driven by central servers that display on centrally located monitors. However, these methods require integrated fixed displays and/or dedicated display information. In addition, these methods are costly, time consuming, and difficult to implement.

### SUMMARY

Methods and systems for providing information about production lines in a process environment are provided. In one embodiment, a method for providing a notification of a production line status includes receiving a status indication of a production line from a tracker associated with the production line. The method further includes transmitting the status indication from the tracker to a server. Finally, the method includes transmitting the notification from the server to a client device, wherein the notification comprises the status indication.

The present disclosure generally relates to an electronic item counting system and more specifically, a display system for an electronic item counter. Additionally, the disclosure relates to a system for relaying the electronic item counting information in real time via a central hub and website interface.

### BRIEF DESCRIPTION OF THE DRAWINGS

FIG. 1 is a diagrammatic view of a tracker and hub system implemented in a factory connected to a network in accordance with one embodiment.

FIG. 2 illustrates a tracker on a production line with a display in accordance with one embodiment.

FIG. 3 is a block diagram of an exemplary display system in accordance with one embodiment.

FIG. 4 is a flow diagram illustrating an exemplary method for obtaining and displaying data in an electronic item counting process in accordance with one embodiment.

FIG. 5 illustrates an exemplary user interface that can be rendered in accordance with the embodiment of FIG. 2 in one embodiment.

FIG. 6 illustratively shows the exemplary user interface and additional user defined timers in accordance with one embodiment.

FIG. 7 shows an exemplary user interface with additional informational items relating to a specific process in accordance with one embodiment.

FIG. 8A illustrates an exemplary hub user interface in accordance with one embodiment.

FIG. 8B shows an exemplary hub interface displaying a current tracker data set in accordance with one embodiment.

FIG. 9 is a schematic diagram of an exemplary hub system in accordance with one embodiment.

FIG. 10 is a flow diagram of a method for checking and altering a tracker status in accordance with one embodiment.

FIG. 11 is a flow diagram of a method for conveying system information from the process to the process managers in accordance with one embodiment.

FIG. 12 is a flow diagram of a method of adding new trackers to an existing hub system in accordance with one embodiment.

FIG. 13 is a diagrammatic view of a website implemented in a network in accordance with one embodiment.

FIG. 14 is a diagrammatic view of a home screen on a website display in accordance with one embodiment.

FIG. 15 illustrates a tracker screen on a website display in accordance with one embodiment.

FIG. 16 illustrates a mobile-enabled website display in accordance with one embodiment.

FIG. 17 illustrates a method for checking and altering a tracker status on a website display in accordance with one embodiment.

FIG. 18 illustrates a method for checking and altering a hub status on a website display in accordance with one embodiment.

### DETAILED DESCRIPTION OF ILLUSTRATIVE EMBODIMENTS

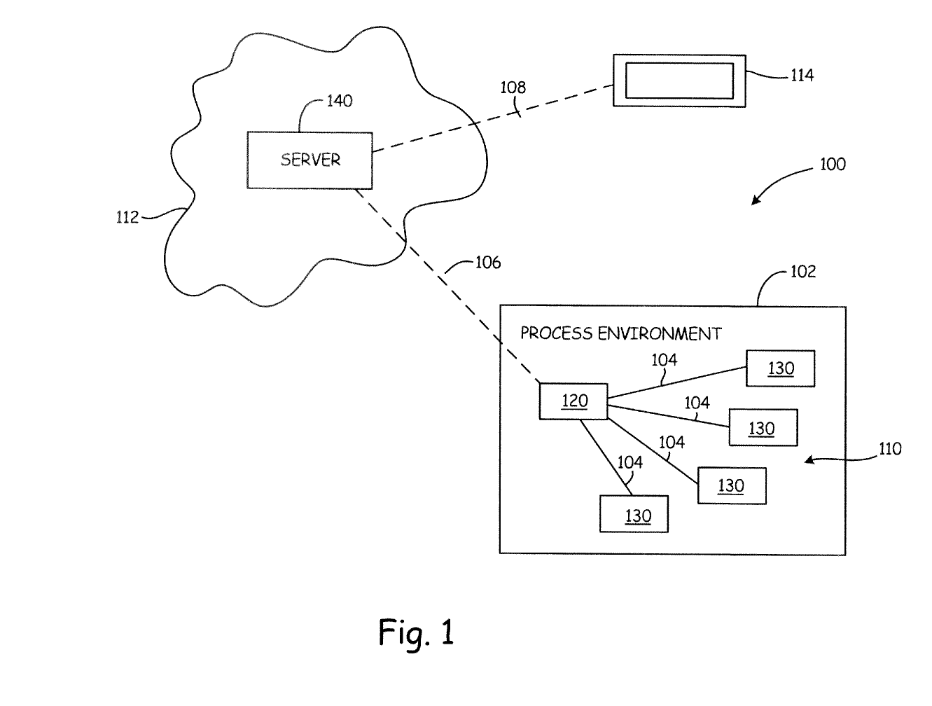

FIG. 1 shows a process update system 100 in accordance with one embodiment of the present invention. The process update system 100 comprises a hub and tracker system 110, a server 140, and one or more client devices 114. In one embodiment, the hub and tracker system 110 comprises a hub 120 and a plurality of trackers 130 wherein the trackers 130 are connected to hub 120 by hub tracker connection mechanism 104. In one embodiment, the hub tracker connection mechanism 104 could be a wireless connection or alternatively could be an Ethernet connection. The hub tracker communication mechanism 104 could comprise any communication mechanism that allows the plurality of trackers 130 to send updated information to the hub 120, such that the hub is updated in real-time, or substantially real-time. As shown in FIG. 1, in one embodiment, the process update system 100 is implemented in a factory 102 or other processing environment. For example, the process update system 100 may be implemented in a processing environment wherein each of the plurality of trackers 130 is attached to an individual process line. The hub 120 and the plurality of trackers 130 will be described in further detail below.

In one embodiment, the hub 120 communicates with the server 140 to transmit information in real time as the information is received from the plurality of trackers 130. In one embodiment, the hub-server connection mechanism 106 is a wireless communication mechanism. However, the hub-server communication mechanism 106 could also be a wired communication mechanism or any other appropriate communication mechanism that facilitates communication between the hub 120 and the server 140. In one embodiment, the hub 120 and the server 140 are located within the same premises 102, for example factory 102 as shown in FIG. 1. However, in an alternative embodiment, the server 140 is at a remote location from the hub 120.

Once the server 140 receives updated information, transmitted in real time from the hub 120 via hub-server communication mechanism 106, the server 140 then, in one embodiment, relays that information through a server-client communication mechanism 108 to a client device 114. In one embodiment, the client device 114 is a computer. However, in another embodiment, the client device 114 could be a tablet, a mobile phone, or any other device able to communicate with the server 140 over the server-client communication mechanism 108. In one embodiment, the server-client communication mechanism 108 is a wireless communication. However, in another embodiment, the server client communication mechanism 108 transmits information from the server 140 to the client device 114 via text message or via e-mail. The server 140 communicates with the hub 120, and with the client device 114 through a network 112 in accordance with one embodiment. This communication could be wireless, in one embodiment, or a wired communication mechanism, or any other appropriate communication mechanism.

While FIG. 1 shows that, in one example, factory 102 includes four trackers 130 connected to one hub 120, it is to be understood that this is only an exemplary embodiment. In an alternative embodiment, factory 102 could have multiple hubs 120 wherein each of those hubs 120 is attached to a plurality of trackers 130, and wherein each of the plurality of hubs 120 transmits information from its network of trackers 130 to a server 140 in real time. In another embodiment, the different hubs 120 communicate with different servers 140, depending on the preferences and the desired set-up of the supervisor/manager of factory 102. Further, the hub 120 is not limited to a specific number of trackers 130 and could comprise as few as one tracker 130 or as many as ten, twenty or otherwise appropriate number of trackers 130 depending on the process being conducted in a processing environment 102.

Now that a broad overview of the system 100 has been described, its individual components, specifically the tracker 130, the hub 120, and the server 140/web interface, will be described in greater detail below.

### The Tracker System

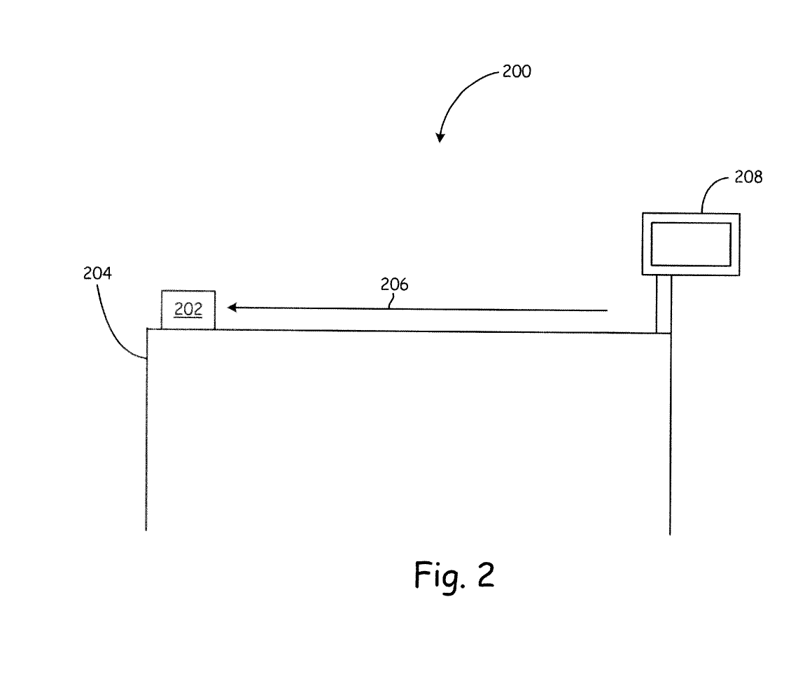

FIG. 2 shows a tracker system 200, in an exemplary embodiment, as part of a production line 204. In one embodiment, the tracker system 200 comprises a tracker unit 202 that is placed on a production line 204, wherein the production line has a direction of movement 206, and wherein the sensors of the tracker unit 202 are configured to detect and count items as they move through the production line in the direction of movement 206. The tracker system 200 also includes a tracker display 208 wherein the tracker display 208 displays in real time a count and speed of the production line 204. The tracker display 208 updates this count and speed in real time and is configured to be able to provide an operator of the tracker system 200 with a series of alerts depending on the needs of the production line. In one embodiment, the tracker unit 202 includes sensors that sense items moving along the production line 204 in the direction of movement 206 such that the tracker system 200 can count the number of units as they pass along the production line 204 past tracker unit 202. The tracker unit 202 further, as it detects and tracks the count of items moving through the production line 204, transmits that information to the tracker display 208, which updates in real time as updated counts are received, thus displaying a real time display of a count of items through the production line 204.

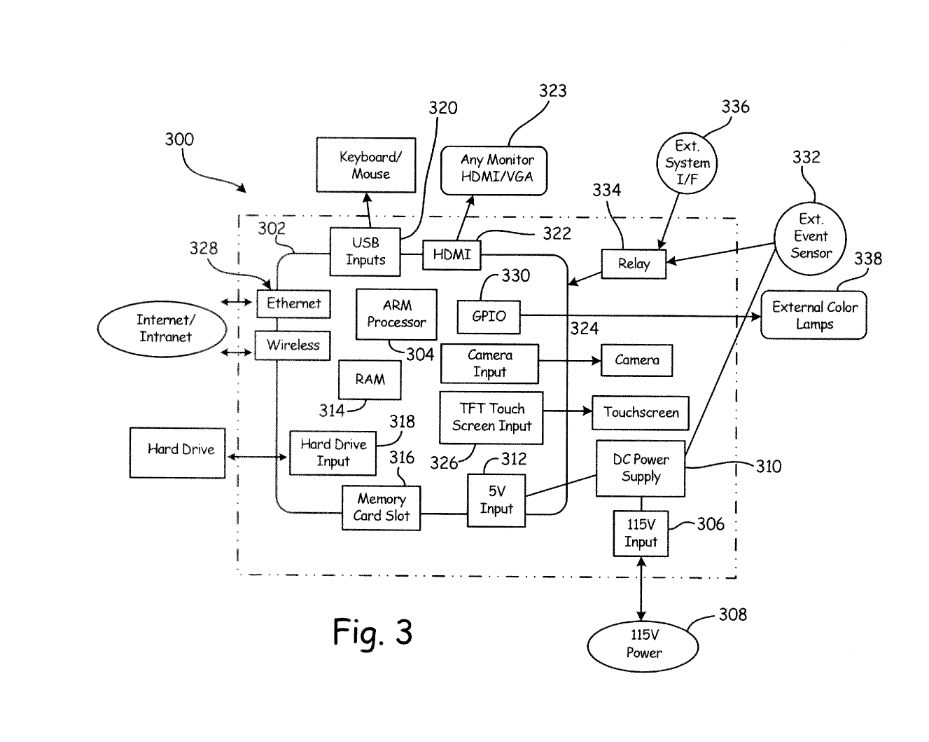

FIG. 3 is a block diagram of a tracker system 300 in accordance with one embodiment. Tracker display system 300 comprises a controller 302 and can be employed in any of a variety of manual, semi-automatic or automatic processes. For example, controller 302 can provide user defined notifications to user-selected personnel and a production process and provide real time production monitoring to user-defined management personnel. In one embodiment, these user-defined notifications to user-selected personnel are conveyed via the tracker display 208 such that an icon or color change or blinking light is presented to indicate that an alert is being given.

One or more of the functions performed by controller 302 can be implemented in hardware, software, firmware, and the like, or a combination thereof. For example, controller 302 can include logic circuitry and/or software instructions stored in a computer readable media. By way of example, computer readable media can be any removable or non-removable media accessible by controller 302. Computer readable media can be volatile or non-volatile.

Computer readable media includes computer readable storage media and computer readable communication media. Computer readable storage media is different from, and does not include, a carrier wave or modulated data signal. Computer readable storage media includes hardware storage media implemented in any suitable technology and storage of information, such as computer readable instructions, data structures, program modules or other data. Examples include, but are not limited to, RAM, ROM, EEPROM, flash memory or other memory technology, CDROM, digital versatile discs (DVD), or other optical disc storage. It can also include magnetic cassettes, tapes, discs or other magnetic storage drives. Communication media typically embodies computer readable instructions, data structures, program modules or other data in a transport mechanism. Return modulated data signal means signal that has one or more of its characteristics set or changed in such a manner as to encode information in the signal.

In the illustrated embodiment, controller 302 comprises a processor 304 having associated memory and timing circuitry (not separately shown) that is a functional part of the system and is activated by, and facilitates functionality of other components or parts of the system. In one example, processor 304 comprises an arm base microprocessor, of which some types include, but are not limited to, single core, dual core, and quad core processing chips (e.g., ARM Cortex-A8, ARM11, Allwinner 1X and 2X).

Any suitable operating system and/or programming language can be used. Exemplary operating systems include, but are not limited to, Linux variations, Android, RISCOS, and Google Chrome to name a few. Exemplary programming languages include, but are not limited to, Python, Basic variations, C, C++, GNU Assembler, GO, Pascal, and JavaScript to name a few.

System 300 includes a power input 306 (e.g., a 115V input from a source 308). A DC power supply 310 provides an input 312 (e.g., a 5V input) for powering controller 302. Controller 302 includes RAM 314 for program code. Alternatively, or in addition, controller 302 can have a memory card input 316 (e.g., an SD card input) and a hard drive input connection 318.

Controller 302 includes one or more input or output interfaces. For example, controller 302 can include one or more of peripheral device interfaces 320, audio/visual interfaces 322, camera interfaces 324, touch screen interfaces 326, and external system or network interfaces 328. Controller 302 can also include a general purpose input/output 330 that can be programmed by a user. Further, controller 302 can include a barcode reader input (not shown in FIG. 1) to receive input data from barcode job tickets, for example.

Peripheral device interfaces 320 can include, for example, serial (e.g., USB) and/or parallel ports, and can be connected to any suitable input devices including, but not limited to, a keyboard, mouse, pointing device, touch screen, touch pad, track ball, scanner, joystick, game controller, and the like. The input devices can be used to provide operator input, such as to user defined goals, system setup and target data.

Audio/visual interfaces 322 can be analog and/or digital. Some examples include, but are not limited to, HDMI, VGA and DVI interfaces, to name a few. In one example, through interfaces 322, controller 102 provides video output of feedback, and/or user defined data to monitors 323, such as real time count, timer, and target goal data. The data can be provided in numerical and/or graphical format (e.g., bar, line, pie and table graphs) independent of the size or type of the display (e.g., monitor). Controller 302 can provide for user defined display information and automatically scale to any size display. Other peripheral output devices (e.g., speakers or printers) could also be included but have not been illustrated.

In one example, through interfaces 328, controller 302 can provide output data to other system controllers, computers, and servers. For example, wired and/or wireless connections can be used to communicate through a network, such as an intranet or internet. In one embodiment, this connection is used to communicate with the hub 120 directly.

Camera interfaces 324 are illustratively configured to receive picture and/or video data from the one or more cameras, which can be onboard or remote. In one example, the camera data provides for a remote visual inspection of a workstation or processes via intranet or internet applications. User selectable timeframes can be provided for taking pictures or video clips and storing for later review and analysis of workstation or production processes. In one embodiment, this picture and/or video data is transmitted to the hub which then transmits the data to the server 140 such that the video and/or pictures are viewable from any client device 114 in real time or historically as desired by the user of client device 114.

Controller 302 receives event inputs from external sensors 332, for example, through a relay 334. Exemplary sensors include, but are not limited to, push buttons, photo sensors, proximity sensors, encoder sensors, and any other suitable type of digital or analog sensors. By way of example, the event inputs are indicative of item counting within a process being monitored (e.g., the number of items being conveyed past a sensor point). Controller 302 can also receive discrete digital or analog signals from any other external system 336.

In one embodiment, controller 302 is configured to provide signals to external color lamps 338 such as four color LED lamps. Alternatively, or in addition, graphical and/or lights can be provided on monitors 323.

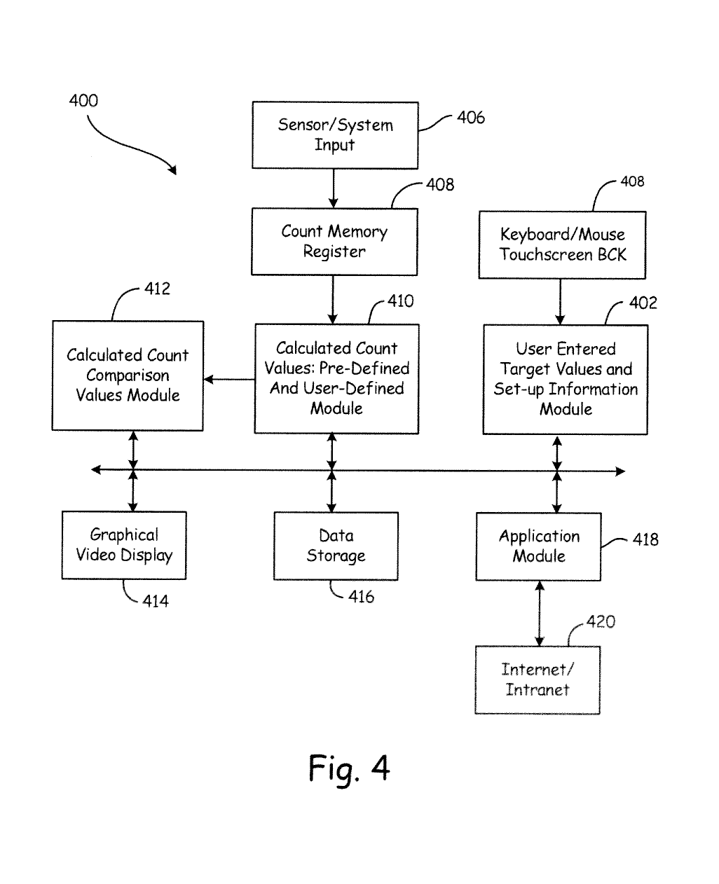

FIG. 4 is a flow diagram illustrating an exemplary method 400 for obtaining and displaying data in an electronic item counting process. For purposes of illustration, but not by limitation, method 400 will be described with respect to the systems of FIGS. 1, 2 and 3.

At block 402, a user enters target values and/or other setup information through input device 404. For example, in one embodiment, input device 404 is a keyboard. However, input device 404 could also be, in another embodiment, a mouse, a touch screen, a barcode reader, and the like. The user can adjust system or process goals and configure what and how information is displayed. Some user input examples include a target speed and a pace counter which sets a production pace of a liner process. The user can enter a value as well as a time, for example in minutes, in which to increment the counter. The user can also define timers, which can define a runtime of the process, a downtime, a break time, a setup time, etc. In one embodiment, this process can also be completed on a hub interface instead of a tracker display interface.

Controller 302 can also facilitate user entry of any other user defined goals and/or customization to the data display. For example, the font size and maximum number of characters per counter field is scalable.

At block 406, input indicative of item counting is received from event sensors 332. The item counting data is stored in a count memory register at block 408. For example, the item counting data can be stored in RAM 314. Alternatively, the item counting data could be sent to the hub 120 and further to the server 140 where it could be stored in the remote location housing the server 140.

At blocks 410 and 412, the count values are calculated and compared to the user defined goals and variables. For example, an actual count and speed can be calculated from the input 406. The data is displayed on monitors 323 at block 414 and can be stored at block 416.

At block 418, an applications module can provide notifications of user defined criteria, system status, and count data via applications for smart devices, for example phones and tablets and personal computers. Example notifications include, but are not limited, low or out of product notifications to material handling personnel, system setup notifications to supervisors or technical personnel, process needs service notifications to maintenance personnel, default and/or operator inputted messages for addition detail, user defined percent behind target notifications to supervisors and managers, and system idle notifications for user defined time limits. It should be noted that while the tracker 130 can provide these notifications through the tracker display 208, these notifications can also be sent to the hub 120 which can send them to the server 140 which can then transmit them to the designated personnel. In one embodiment, the server 140 can transmit these notifications to these personnel via text message or via e-mail. Alternatively, in another embodiment, these notifications could be sent to the designated personnel from the hub 120 directly, bypassing the need for the server if, for example, the server is unavailable or offline.

The data can be transmitted from controller 302 to another system or process at block 420. For example, the data could be sent to the hub 120, and additionally sent from the hub 120 to a server 140. In this manner, a plurality of controllers 302 can be used for a plurality of different process locations, and the data can be transmitted to a common location for monitoring and/or further processing.

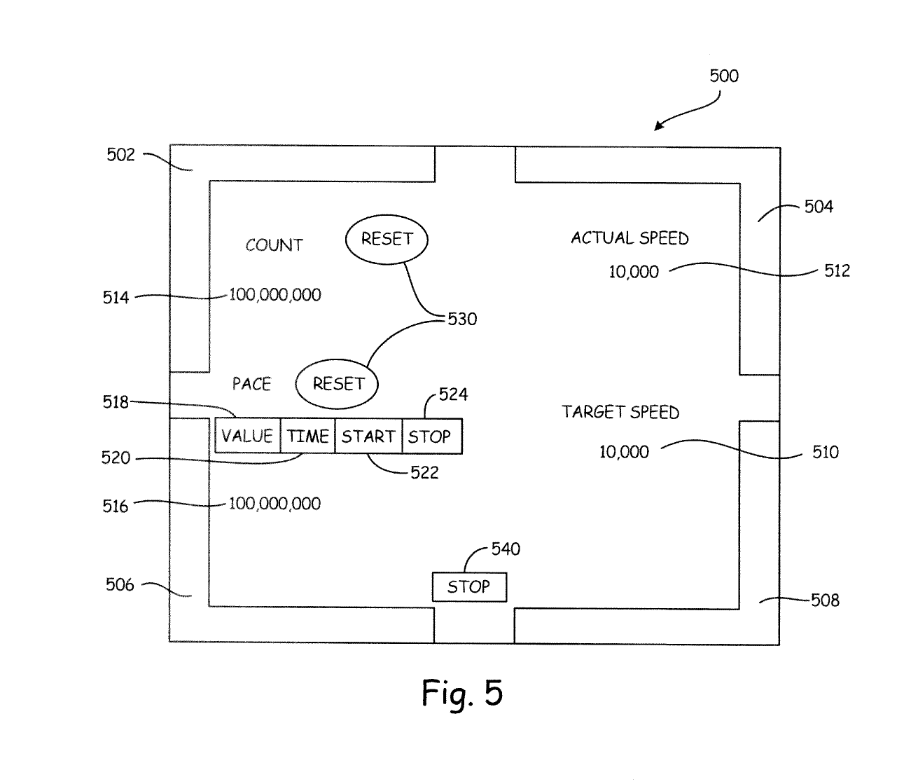

FIG. 5 shows an exemplary user interface 500 presented to an operator on the tracker display 208 in accordance with one embodiment. The exemplary user interface 500 provides a plurality of informational items, including an actual count 514, and actual speed 512, a target speed 510 and a pace 516. In accordance with one embodiment, the user interface 500 can also include a visual indication, for example a graphical light that indicate a state of the system, and can be used to notify management, maintenance, and/or other workers of a quality or process problem. In one embodiment, the light is an Andon light, provided by Signaworks. However, any other appropriate indication mechanism could also be used, in another embodiment, to indicate a system state. By way of example, user interface 500 may include, in one embodiment, a plurality of Andon lights 502, 504, 506, and 508 wherein these lights are green, red, yellow, and blue respectively. Each Andon light 502, 504, 506, and 508 can represent a different process or a different portion of a process and can be controlled manually by a user and/or automatically by the system. In one embodiment, an operator defines which colors and states, wherein states include off, blinking and steady and combinations thereof are associated with particular system statuses.

In one particular example, a green light 502 indicates that the system is running properly. Whereas a red light 504 and blue light 508 on steady indicate that the system is stopped, for example out of product. While a red light 504 and yellow light 506 on steady may indicate that the system is stopped, for example that it needs service at some point along the production line 204. As also shown in the exemplary user interface 500, in looking at the current pace 516 of the system, a user or an operator of the production line 204 has the option to see the pace 516 in a value 518 or a time 520 and has an option to start 522 or stop 524 the pace clock 516 at any given point. For example, if the operator is going on break, the operator may want to stop 524 the time and then start 522 the time when they come back from break and engage the production line 204. Additionally, both the count 514 and the pace 516 can be reset by a user as shown in FIG. 5 through reset buttons 530. Additionally, the entire tracking process can be stopped through stop button 540.

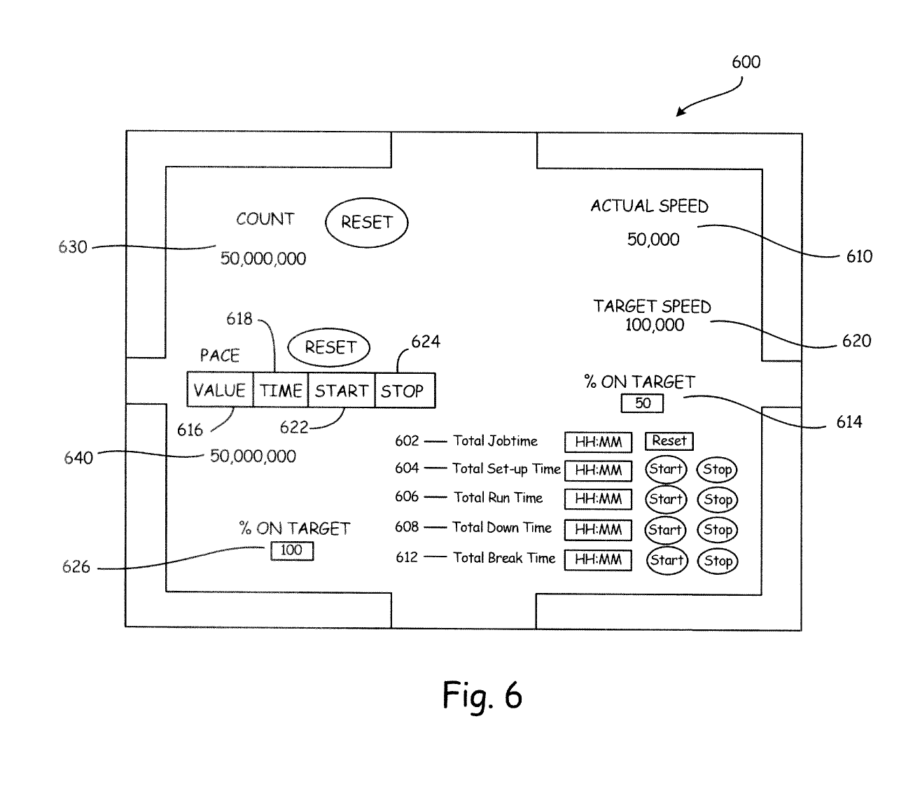

FIG. 6 shows another exemplary user interface 600 that includes additional user-defined timers. The exemplary interface user interface 600 also includes an actual speed 610 as compared to a target speed 620 and an actual count 630 as compared to a target pace 640. This is in addition to the ability to adjust the pace between a value 616 or a time 618 and to start 622 or stop 624 the pace during the process. Additionally, exemplary user interface 600 also shows a percent on target 626 with respect to the count and a percent on target 614 with respect to the speed. These percent on targets 626 and 614 thresholds may, in one embodiment, trigger an alert through one of the four Andon lights as discussed with respect to FIG. 5. Additionally, these percent on target 626 and 614 may trigger an alert to be sent to a supervisor or may indicate to management that there is a problem with the process line. For example, in one embodiment when a job is nearing completion, an alert may be sent to supervisors to prepare for a job shut down process.

Additionally, in one embodiment, there is a series of user defined timers that an operator can interact with through the tracker display 208. These additional user defined timers include a total job time 602, a total setup time 604, a total run time 606, a total down time 608, and a total break time 612. Each of these additional user defined timers can be set in hours and minutes as shown in FIG. 6 or, if more appropriate, could be set in minutes and seconds. Further, while the display in FIG. 6 shows only an option to have two units of time measured, the display 600 could, in another embodiment, support additional units as necessary. For example, the display 600 could be configured to support a view of days, hours, minutes and second simultaneously. The total job time 602, in addition, has a reset button so that at the end of a job, and before a new job begins, the time can be reset to zero. Additionally, each of the other additionally user-defined timers have a start and stop button so that an operator can accurately record time spent during setup, run time, down time, and break time in order to accurately convey how time is used within a process system.

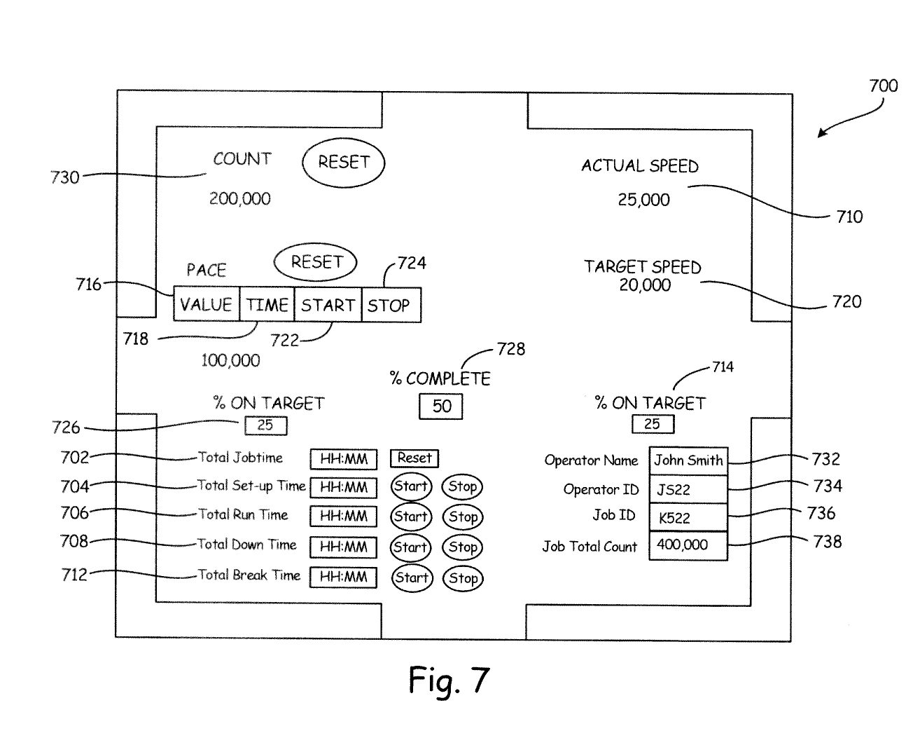

FIG. 7 shows another exemplary user interface 700 in accordance with one embodiment. In addition to the features of the user interface as shown in FIGS. 5 and 6, some of which are also included in the exemplary user interface 700, (including for example: actual speed 710, a target speed 720, a count 730, and a pace 740 with the ability to view value 716 as opposed to time 718 and an ability to start 720 or stop 724 the pace 740) user interface 700 also includes a percent on target 726 with respect to the count and a percent on target 714 with respect to the speed. Further, exemplary interface 700 also includes a percent complete 728 which refers to the percent of the entire job that has been completed which is based on a target count. For example, as shown in FIG. 7, there currently have been 200,000 units produced as shown by count 730 and as the percent complete 728 shows that the job is 50% completed, a total count of 400,000 is the target for this particular job. Additionally, user defined timers 702, 704, 706, 708 and 712 are also available. Additionally, FIG. 7 also includes additional information items which may, for example, be entered by an operator upon starting a shift on a production line. Alternatively, these additional information items could be entered by a supervisor at a hub location and not editable by a specific operator through the tracker display user interface. These additional items include an operator name 732, an operator ID 734, a job ID 736, and a job total count 738. For example, as shown in FIG. 7, the particular operator of this tracker is named John Smith, his ID is J522, the job ID is K5S2 and the job total count is 400,000.

### The Hub System

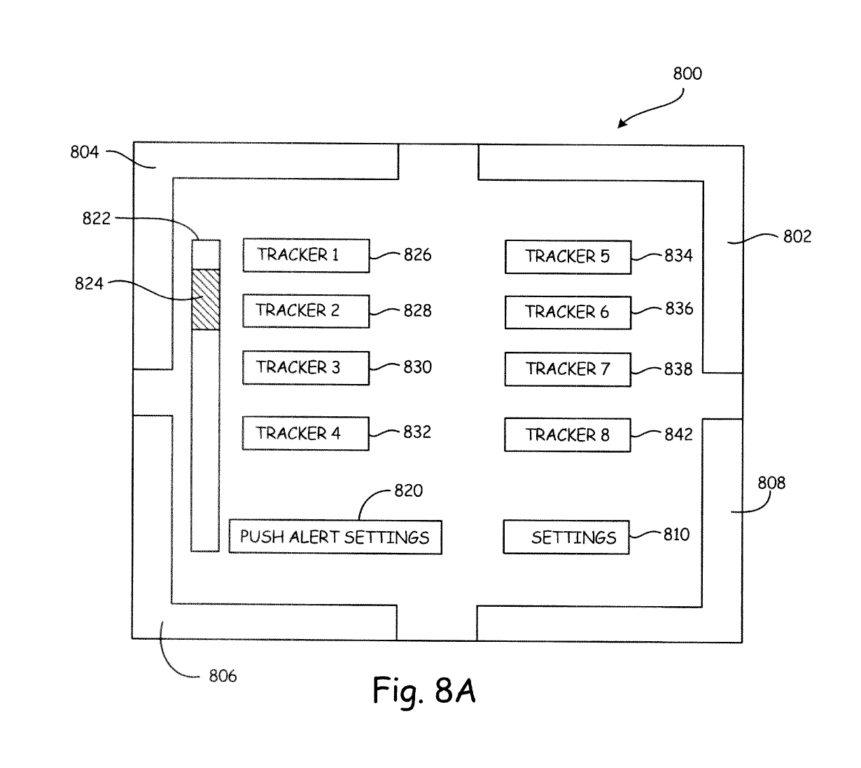

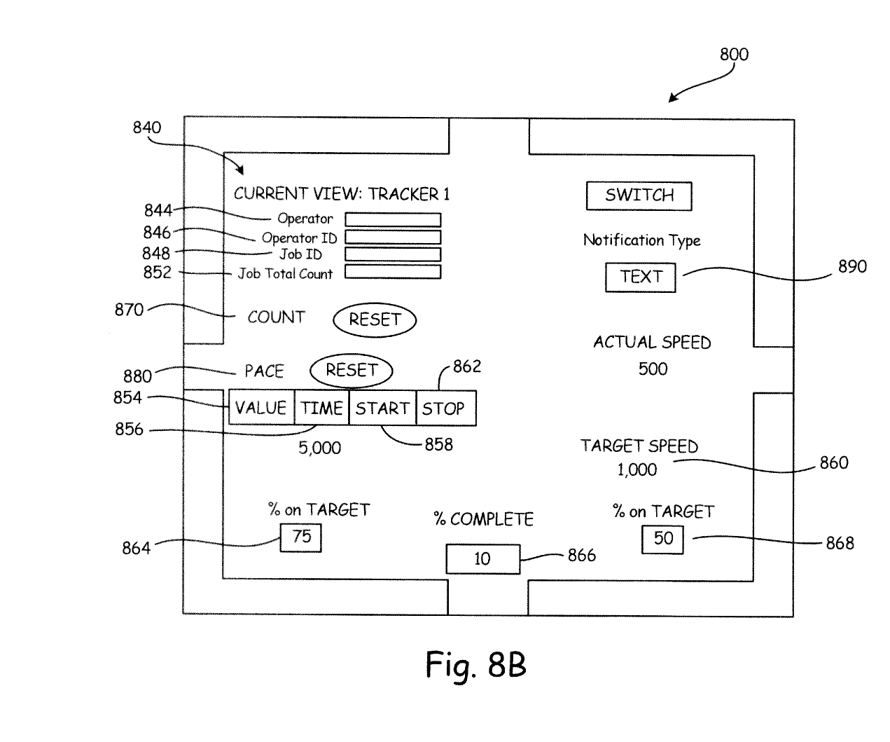

As described above, each individual tracker 130 in a hub and tracker system 110 reports to a central hub 120. The central hub 120, in addition to serving as an aggregation mechanism for the plurality of trackers 130 also allows an operator or supervisor to view the productivity and status of the plurality of trackers 130 and, additionally, to change any one of a series of settings specific to any of the trackers 130. This management functionality is provided, in one embodiment, through a user interface as exemplified by hub user interface 800 shown in FIGS. 8A and 8B.

The hub user interface 800 may, in one embodiment, require a login by a supervisor or manager of the process system and may not be accessible by an ordinary operator on the process line. This login may comprise, for example, a username and password. However, in another embodiment the login could be biometric based—through a biometric sensing system, for example a finger print scanner.

In one embodiment, the hub user interface 800 shown in FIGS. 8A and 8B has at least the same control capabilities and display capabilities of the tracker display 208—including the ability to enter operator information or job information and to see current statistics related to the productivity of each tracker 130. Additionally, as shown in FIG. 8, hub interface display 800 first presents a user with a plurality of alert corners wherein these alert corners may comprise Andon lights in a similar configuration as described with respect to the tracker interface 500 and wherein these alert corners 802, 804, 806, and 808 may be programmed to provide alerts based on an individual tracker 130 or, in particular, may be configured to provide an alert whenever a tracker relays such an alert to the hub system 120.

The hub interface display 800 also includes a settings icon 810, in one embodiment, wherein clicking on settings icon 810 allows a user to display and change settings related to either the hub interface display 800 or a specific tracker interface display 500. For example, the user may decide to change the language of a hub display, for example from English to French, German or Spanish. Additionally, the user may set the language to change automatically, for example based on a shift change in order to accommodate the majority of operator preferences during different shifts. With respect to shift specific settings, the hub interface display 800, through the settings icon 810, may allow a system supervisor or manager to set settings specific to either, for example a day or night shift or for example based on specific days of the week for example Monday-Friday or Saturday-Sunday. For example, in one embodiment, alerts generated on a Monday-Friday may be directed to a different supervisor than alerts generated on Saturday-Sunday.

Additionally, hub interface display 800 also includes, in one embodiment, a push alerts icon 820 wherein a system supervisor can set specific alerts related to one, multiple or all of the trackers 130 that will push to a selected supervisor's phone or smart device through either text messaging, e-mail or a phone call. Additionally, in another embodiment, any other appropriate means for relaying alerts to a supervisor in real-time is appropriate. These alerts are extremely helpful for supervisors who may not be present at the plant where the hub 120 and plurality of trackers 130 are located. These alerts for example as discussed previously, could include a low product indication or a malfunction.

Hub interface display 800 displays information relative to a plurality of trackers 130 that are connected to the hub 120, in one embodiment. A user of the hub interface display 800 can select any one of the displayed trackers 130 to view detailed statistics or parameters related to the selected tracker 130, or to change settings specific to the selected tracker 130. In one embodiment, the hub interface display 800 shows up to eight trackers 130 at a time for example via tracker icons 826, 828, 830, 832, 834, 836, 838 and 842, however, in another embodiment, hub interface 800 may include more or fewer icons related to trackers 130. The inclusion of more or fewer trackers 130 may be based on the size of the output display in one embodiment or may be a setting that the user could change in the settings icon 810. However, if there are more trackers 130 connected to a specific hub 120, these trackers 130 could be shown by moving the scroll icon 820 up or down on the scroll bar 822.

Additionally, it should be noted that while FIG. 8 shows a plurality of trackers 130 with names such as tracker 1, tracker 2, etc., in one embodiment, a supervisor could name the trackers 130 for example to be specific to the production line 204 to which each of the trackers 130 are assigned. However, in one example, as shown in FIG. 8A, the trackers 130 are assigned names by default in the order in which they are connected to a hub 120. Additionally, while FIG. 8A only shows names for a plurality of trackers 130, it may, in another embodiment, show a summary of statistics for each of the plurality of trackers 130. Further, while the Andon lights 802, 804, 806 and 808 may be programmed to display alerts for any combination of the trackers 130, the plurality of tracker icons 826, 828, 830, 832, 834, 836, 838 and 842 may also be configured to indicate alert status for their indicated tracker 130, for example via color on the hub interface display in accordance with the alert formats described above.

FIG. 8B shows the hub interface display 800 after a user of hub interface display has clicked on tracker icon 826. The hub interface display 800 now displays a current view 840 that shows a user which tracker 130 the user is currently viewing. The hub interface display 800 also shows an actual speed 850 of the specified tracker as compared to a target speed 860 of the specified tracker and a count 870 as compared to a pace 880 of the specified tracker 130 wherein the pace 880 can be viewed as a value 854, or time 856 and wherein the user could start 858 or stop 862 the pace from the hub user interface. In one embodiment, starting 858 or stopping 862 the pace 880 from the hub user interface 800 sends an indication to the corresponding tracker 130 to start or stop its pace clock as well. However, in an alternative embodiment, the pace of the hub and the pace of the individual tracker are not connected.

The hub interface display 800 of FIG. 8B also includes a percent on target 864 with respect to the count 870 and a percent on target with respect to the speed 868. It also includes a percent complete 866 with respect to a current job. Additionally, the hub interface display 800 also includes a notification type 890 wherein, as shown in FIG. 8B, the notification type 890 for tracker 826 has been selected as a text messaging format. This notification type 890 allows a supervisor to set a preference as to what kind of notifications they would like to receive based on an individual tracker 130. In another embodiment, the notification type 890 would further allow a user of the hub interface 800 to indicate which supervisor or operator a notification should be sent to in the case of different types of alerts. For example, if the alert is a low product indication, that may require an alert to be sent to a different supervisor than if the alert type is a maintenance required alert. Additionally, the hub interface display 800 also includes operator specific details specific to the selected tracker 130 including an operator 844, and operator ID 846, a job ID 848 and a job total count 852. In one embodiment, these items are editable only through the hub interface 800 and are not editable by a specific operator of a specific tracker 130 through the tracker display 208.

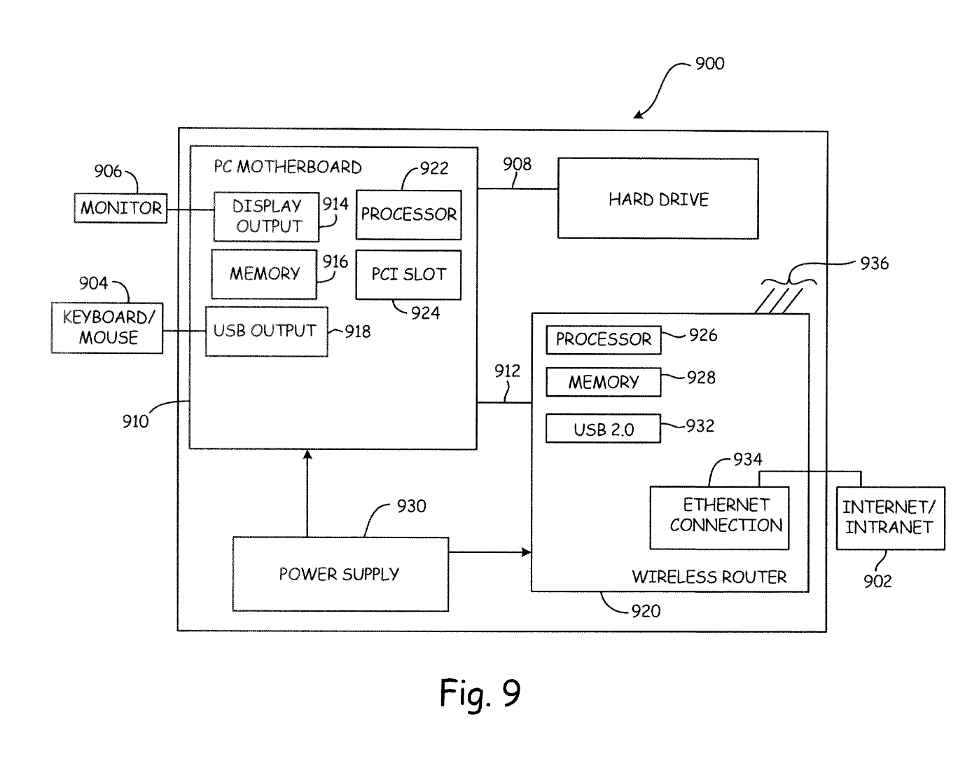

FIG. 9 shows a hub internal configuration 900 in accordance with one embodiment. In the illustrated embodiment, the hub internal configuration 900 includes a PC motherboard 910, a wireless router 920, a power supply 930 and a hard drive or storage component 940. The power supply 930 provides power to both the PC motherboard 910 and the wireless router 920. The PC motherboard 910 further provides power to the hard drive 940 through power connection 908. In one embodiment, the PC motherboard 910 communicates with the wireless router 920 through communication link 912. In one embodiment, the communication link 912 is an Ethernet communication. However, any other appropriate communication option could be used. In one embodiment, the PC motherboard comprises, a memory 916, a USB output 918 wherein the USB output 918 is connected to a keyboard and/or a mouse 904, a processor 922, a PCI slot 924 and a display output 914 that is connected to a monitor 906. In one embodiment, the display output 914 is configured to provide HDMI output to an HDMI enabled monitor 906. In one embodiment, multiple display outputs can be provided from a single hub 120. In one embodiment, the USB output 918 communicates with a multitude of USB capable devices, for example in one embodiment, a user input means 904, for example a keyboard or a mouse.

The hub internal configuration 900 also includes a wireless router 920 where the wireless router 920 comprises a processor 926, a memory 928, a USB 2.0 932 and an Ethernet connection 934. In one embodiment, the Ethernet 934 is connected to an internet/intranet 902. In one embodiment, the Ethernet connection 934 is connected to both an internet/intranet 902. For example in one embodiment, the hub 120 may be connected through a wired connection mechanism to the plurality of trackers 130 but may be connected wirelessly to the server 140. Additionally, the wireless router 920 further includes a plurality of antennae 936.

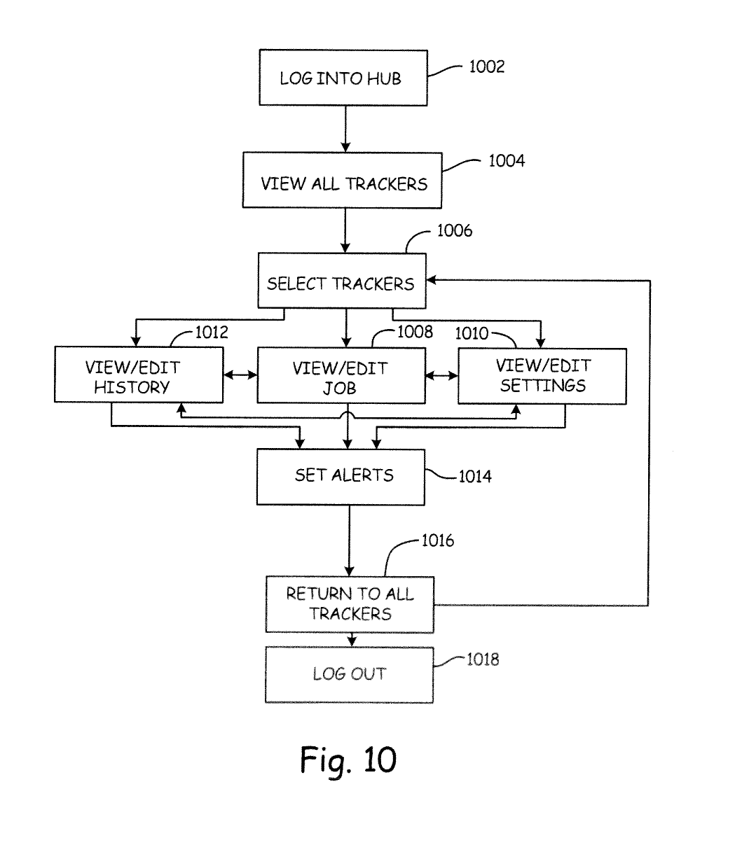

FIG. 10 shows a method of modifying the settings of a particular tracker 130 using the hub user interface 800. At block 1002, a user, for example a supervisor or manager, logs into the hub interface 800 shown in FIGS. 8A and 8B. In one embodiment, logging into the hub user interface may require entry of a user name and password as the hub interface 800 may be limited to viewing by supervisors or management personnel only. However, in another embodiment, logging into the hub user interface 800 may be as simple as turning on a hub display and interacting with the hub user interface 800. In a further embodiment, the logging into the hub user interface 800 may comprise the hub 120 keeping track of who has logged in at specific times so that a history can be kept of who made what changes, at what times, with respect to which trackers 130.

In block 1004, the operator is taken to a view all trackers 130 screen, for example the view all tracker 130 screen as shown on the hub user interface 800 in FIG. 8A. In one embodiment, the user may view a plurality of trackers across multiple screens for example as described in FIG. 8A. However, in an alternative embodiment, the hub 120 may be connected to a single tracker 130 wherein by logging into the hub at block 1002, the user may automatically view all of the trackers 1004 and wherein blocks 1004 and 1006 may be merged into a single block.

The user then, in block 1006, selects a specific tracker 130. The user then has the option to view or edit current job settings in block 1008, view or edit the tracker settings in block 1010, or view or edit the history for that tracker 1012.

In one embodiment, viewing or editing the job, as indicated in block 1008, may allow the user to, in one embodiment, view the current job statistics and information about the tracker 130 selected, for example information specific to the operator and/or the job as shown in FIG. 8B. Alternatively, the user can view or edit settings specific to the selected tracker 130. This may include, in one embodiment, setting a multiplier for the tracker 130 specific to a job such that, when the sensor senses an item moving along the direction of production, it counts a multiple that reflects the actual number of units, for example when multiple units move along the production line at a time. In another embodiment, viewing or editing the job, as indicated in block 1008, may include altering the language viewed on the selected tracker 130.

Additionally, in one embodiment, the user may also select, as shown in block 1010, to view or edit settings specific to the selected tracker 130. As described above, these settings may include, for example, changing the language specific to the selected tracker 130 during specific shifts or days of the week. Alternatively, the settings may include, for example, the specific alert sequences for the Andon lights on tracker display 208 for the selected tracker 130.

Further, the user may select to view or edit the history regarding that specific tracker 130 in block 1012. This may be of particular importance when a supervisor is determining when a particular problem took place. In this case, viewing or editing the history of the selected tracker 130 may include seeing a full history of all alerts that have been issued from that particular tracker 130 or viewing a limited history for example viewing only alerts that were sent from that particular tracker 130 during a particular shift or during a particular time period. Additionally, viewing or editing the history with regard to a specific tracker 130 may indicate to the supervisor which operators have been operating on the tracker 130 at different time periods during the last series of shifts.

After a user has completed one of blocks 1008, 1010, or 1012, the user may cycle between them and complete one, two or all three of those options. Then the user is taken to block 1014 wherein the user has, in one embodiment, the opportunity to set alerts for the selected tracker 130. For example, the user may be selecting particular alerts specific to trackers they are responsible during shifts they supervise. The user may, in one embodiment, set alert types as well. For example, alert types may be a text message or an e-mail notification based on a specific alert. For example, the user may want a text message for a low product indication, and an e-mail for a maintenance needed indication.

Once the user has completed setting alerts in block 1014 with respect to a selected tracker 130, the method will, in one embodiment as indicated by block 1016, return the user to the all tracker screen where the user can then repeat the process of blocks 1006, 1008, 1010, 1012 and 1014 until the user has completed the desired editing for the plurality of trackers 130 that the user wants to edit. Then, in one embodiment, the user is presented with a log out screen where the user may to log out to end the session with the hub 120. In one embodiment, any edits for a specific tracker 130 or settings for the hub 120 are made once the settings have been entered by a user. However, in an alternative embodiment, the settings are not entered or changed until the user has logged out of the hub system, or at least until the user has indicated a desire to save the edits made.

The system described above enables a method, in one embodiment, for collecting information from a process system and making it available to supervisors through the hub interface 800, a web interface, and/or on a client device 114. As described above, the ability to make information available for and push alerts to supervisors who may or may not be on site is very important for a process system. Without such a system, it may unclear why a particular alert is sounding, which production line 204 is indicated by the alert, or which supervisor needs to respond to the alert. For example, a maintenance indicated alert likely requires a different supervisor than a low product alert.

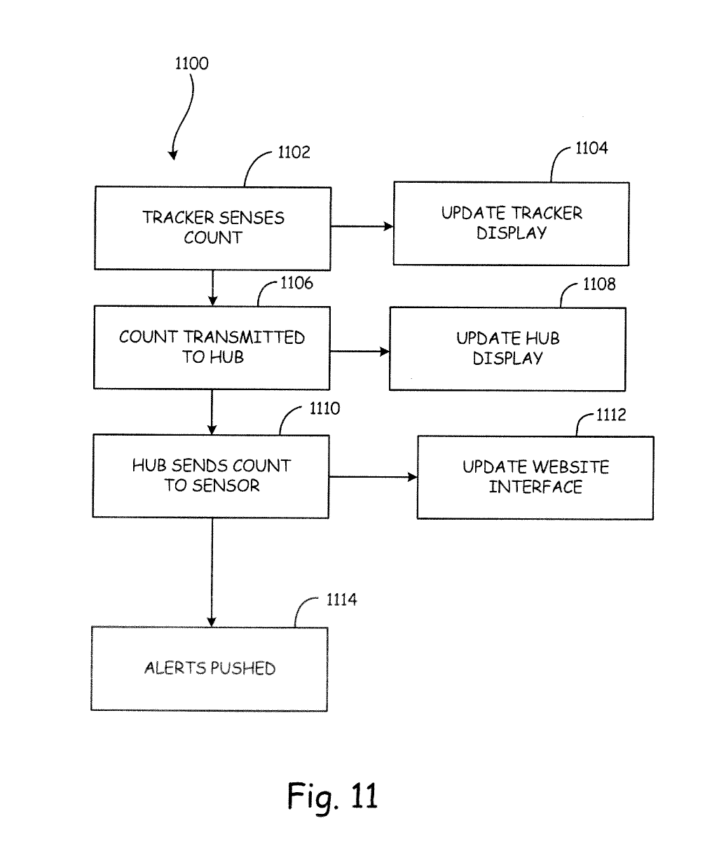

FIG. 11 is a flow diagram of a method for conveying information to supervisors through the hub 120, the server 140, and the client device 114. Block 1102 shows the tracker 130 sensing a count on a production line 204. Once the tracker 130 senses a new item moving through the production line 204 on direction 206, it updates the count and also updates the tracker display 208 in block 1104. Thus, an operator in view of the tracker display 208 can see the count as it updates in real time. In addition to updating the count in block 1104, the tracker also will update any alert statuses or production line statuses. For example, if the tracker 130 detects that the product is low, it will initiate a low product alert. Thus, anyone who can view the tracker display 208 is able to see an alert from the production line 204 as soon as it is detected by the tracker 130.

While the tracker 130 is updating the tracker display 208, it is also transmitting the current count and any alert statuses to the hub 120, as shown in block 1106. A plurality of trackers 130 are moving through this process of counting, displaying and transmitting in real time updated information to the hub 120, where the updated information comprises current counts and current alert statuses for each of the trackers 130. So while FIG. 11 only shows a single tracker 130 sending a count to the hub 120 in block 1106, this process can also, in one embodiment, be running in parallel across all of the trackers 130 connected to the hub 120 in a specific process system, such as factory 102.

Once the count is transmitted to the hub 120 from an exemplary tracker 130, as shown in block 1106, the hub 120 updates the hub display as shown in block 1108. In this way, if any operator, supervisor, or manager is viewing the hub display, they can view in real time a current count for the tracker 130 as well as any current alerts. Additionally, as alerts for the trackers are color coded on both the tracker display 208 and the hub display, anyone viewing the hub display can quickly gather an understanding of any issues on the production line 204, broken down by type of issue and tracker 130 reporting the issue.

While the count is being updated on the hub display, the hub 120 is also transmitting the count and any associated alerts to the server 140 as shown in block 1110. The server 140 then updates a website interface as shown in block 1112. As will be described in detail, much of the functionality shown on the tracker display 208, and available through the hub interface 800, is also available through the website interface so that a supervisor does not have to be on site in order to view the hub interface 800 and obtain a current status or edit settings with regard to the plurality of trackers 130. Instead, the supervisor can still keep track of what is going on for a specific process location 102, or in another embodiment, what is going on for a series of process locations 102 containing hubs 120 in multiple locations through a single website interface.

As shown in FIG. 11, the tracker display 208 is updated prior to the hub display which is updated prior to the website interface in blocks 1104, 1108 and 1112, respectively. However, as the count is being updated constantly throughout a process, for example at least once per second in one embodiment, these displays are substantially all in real time and substantially all show the same count at the same time such that an operator viewing the tracker display 208, a supervisor viewing the hub display and a manager viewing the website interface all see the same count for a specific tracker 130 at a specific point in time. Additionally, while the hub 120 is sending the count to the server 140, the server 140 then pushes alerts to the appropriate supervisors or managers as shown in block 1114. In one embodiment, the alerts are sent from the server 140 directly. However, in another embodiment, the alerts are sent directly from the hub 120 to the appropriate supervisor or manager.

In a further embodiment, in addition to alerts and statuses moving from a tracker 130 to a hub 120 to a server 140, an operator of a production line 204 can enter a comment or concern through the tracker display 208 and an attached keyboard. For example, an operator may wish to indicate that, while maintenance is not required, start-up of a production line 204 took longer than normal. Such comments may, for example, be transmitted from the tracker 130 to the hub 120 and further to the server 140.

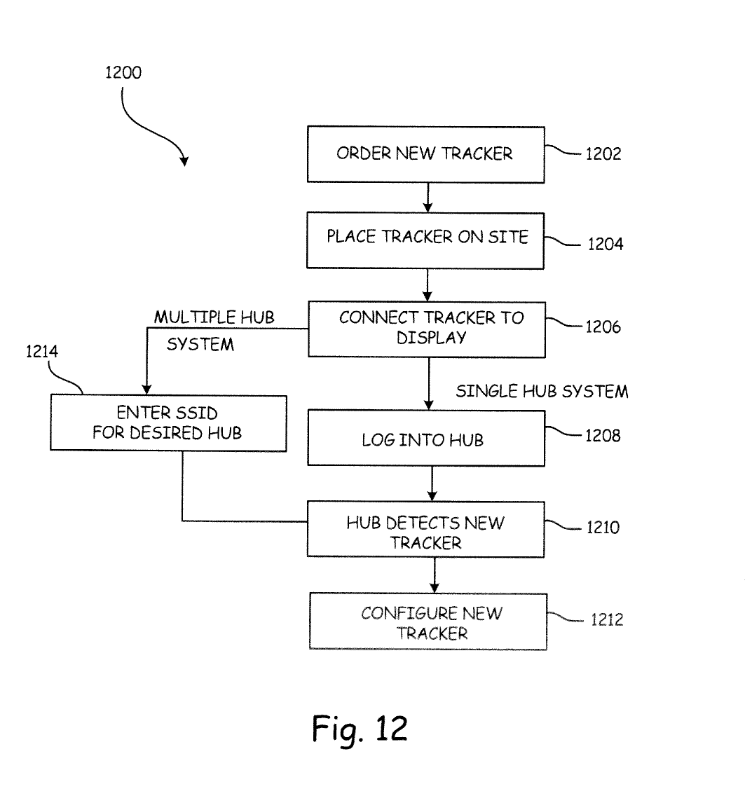

FIG. 12 is a flow diagram of a method for adding a new tracker 130 to an existing hub and tracker system 110. In one embodiment, upon installing a new production line 204, a client company may decide that they need a new tracker 130 to add to their existing system. Thus, in block 1202, they may decide to order a new tracker 130. In one embodiment, when ordering a new tracker 130, the customer may decide to have the tracker 130 pre-programmed to be associated with a specific hub 130. For example, in one embodiment, the seller of the trackers 130 and hub 120 may keep track of specific IDs related to each hub 120 and each tracker 130 purchased by a specific client company, and thus can pre-program a tracker 130 to one of a series of hubs 120 purchased by the client company.

In one embodiment, in block 1204, the client company may then place the tracker 130 on a process site 102 and thus align the sensors of the tracker 130 on a production line 204 such that they are properly set up to sense and count items moving on the production line 204. In block 1206, the user plugs the tracker 130 into a tracker display 208. As discussed previously, the tracker 130 operates and counts items on a production line effectively by itself and does not need to be connected to a particular hub 120 to operate. Thus, if a customer does not have a hub 120 or does not want to plug a tracker 130 into a specific hub the method ends here, in accordance with one embodiment.

If the client has a single hub 120 in their process environment 102, all the client needs to do to continue the installation of the tracker 130 into their system is to log into the hub 120, as shown in block 1208. After logging in, which may not be required in some embodiments, the hub 120 will automatically detect the new tracker 130, as shown in block 1210. Once detected, the hub 120 will then prompt the client to configure the new tracker 130 in block 1212, where configuring may comprise, in one embodiment, naming the new tracker 130 or setting initial settings for the tracker 130, such as language for the tracker within the hub and tracker system 110.

However, in the embodiment where the client has a process environment 102 that includes multiple hubs 120, after connecting the tracker 130 to the tracker display 208, as shown in block 1206, the client will need to, as shown in block 1214, enter a specific SSID for the desired hub to which the new tracker 130 should connect. Once the specific SSID for a desired hub has been entered in block 1214, the method then continues to block 1210 as if the process environment 102 had a single hub 120. The indicated hub 120 will detect the new tracker 130, and then the user can configure the new tracker 130 as shown in block 1212.

This method is designed such that once a tracker and hub system 110 have been purchased, all a user typically needs to do is install the trackers 130, where desired, and turn on the hub 120. Once turned on, the hub 120 will automatically detect the plurality of trackers 130 that are turned on and present within the process environment 102. In this way, once the hub 120 has been provided with an Ethernet connection for the wireless router 920, the system is self-contained within its own intranet system. Thus, installing the tracker 130 in tracker and hub system 110 does not require the involvement of an IT group within the process environment 102. This reduces the cost for the setup of a system 100 and reduces the difficulty. In a similar fashion, installing a new hub 120 within a system 100 for example to transfer a single hub system to a multiple hub system a user merely needs to install the second hub 120 with its own Ethernet connection and then go to the trackers 130 that the client wants to report to the second hub 120 and, as shown in block 1214, enter the SSID code for the second hub 120 and then the second hub 120 will detect the new trackers 130.

### The Web Interface System

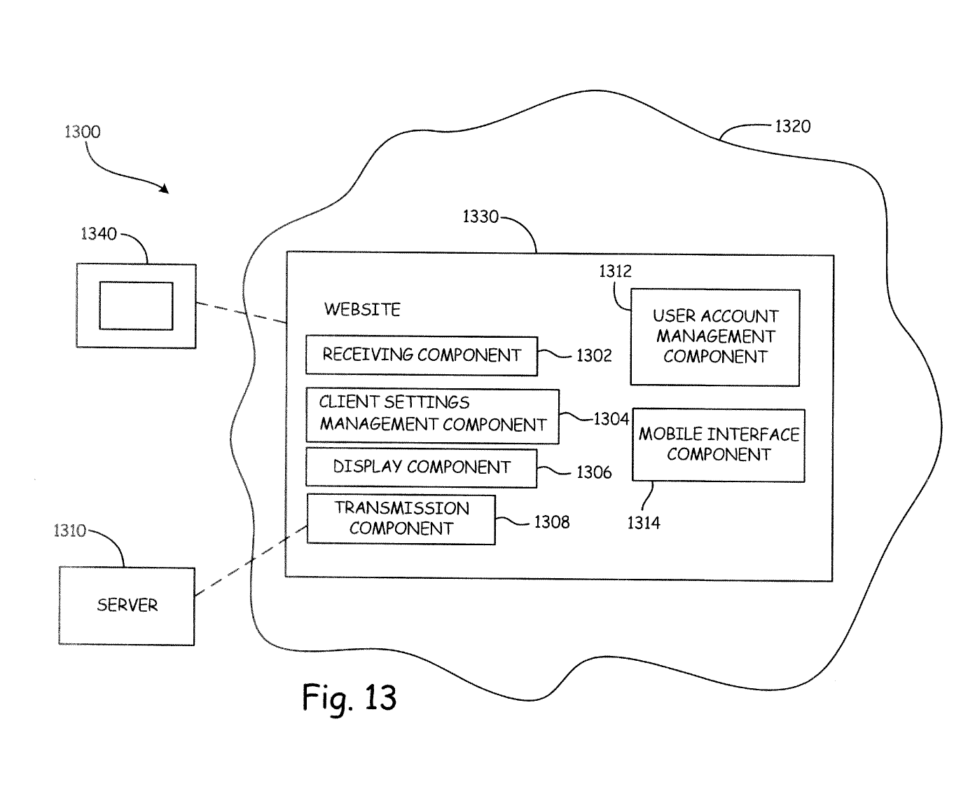

As shown in greater detail in FIG. 13, the process update system 100 comprises a plurality of trackers 130 that convey an updated count in real time to a hub 120, which further transmits the updated count to a server 1310, which further provides the information to a website 1330, over a network 1320, that is accessed by a client through a client device 1340. The client device 1340 may be, in one embodiment, a computer or laptop. In another embodiment, the client device 1340 may be a smart phone or a tablet. In a further embodiment, the client device 1340 may be any device with a display capable of wired or wireless access such that it can access the website 1330. In one embodiment, the network 1320 is a wired network. In another embodiment, the network 1320 is a wireless network.

In one embodiment, the website 1330 comprises a receiving component 1302 that receives updated information in real time from the server 1310, where updated information comprises at least updated count, status, and alert information specific to each of the trackers 130 reporting to hubs 120, which in turn transmit the same data on to servers 1310. The website 1330 also comprises a transmission component 1308 such that a viewer of the web site 1330 can transmit information to another party—for example a supervisor viewing the website 1330 could transmit status information for a particular tracker 130, viewed on the website 1330, to a manager on-site. The transmission component 1308 could be, in one embodiment, an e-mail communication facilitation component. Or, in another embodiment, the transmission component 1308 could facilitate the sending of a text message.

The website 1330 may also comprise, in one embodiment, a display component 1306 that takes the received information from the receiving component 1302 and updates the displayed information on the website 1330 such that a viewer of the website 1330 is always viewing up-to-the second information transmitted in real time from the process environment 102. Further, in another embodiment, the website 1330 also comprises a mobile interface component 1314 that supports viewing of the website 1330 on a non-standard website viewer, for example on a mobile phone or a tablet computing device.

The website 1330 may also comprise, in one embodiment, a user account management component, that manages which clients of the website provider can see which data. For example, in one embodiment, access to the web interface is provided to client companies on a subscription basis and, in exchange for a subscription fee, the client company is given an access key to the website to view data specific to their process environment 102. In this way, the client company has access to the information concerning their tracker and hub update system 100, but it is kept secure from others behind the security of an access key. In one embodiment, the access is provided in the form of a username and password log-in scheme. In another embodiment, a client company is given a plurality of log-in accesses such that a series of supervisors and managers of the client company can log in to the website 1330.

The website 1330 further comprises a client settings management component 1304, that stores the settings for a particular client company and, further, for each individual log-in access of the client company. For example, in one embodiment, each supervisor or manager can customize their view on the website 1330 upon logging in. In this way, supervisors can choose to prioritize alerts and statuses for the trackers 130 corresponding to production lines 204 that they are responsible for.

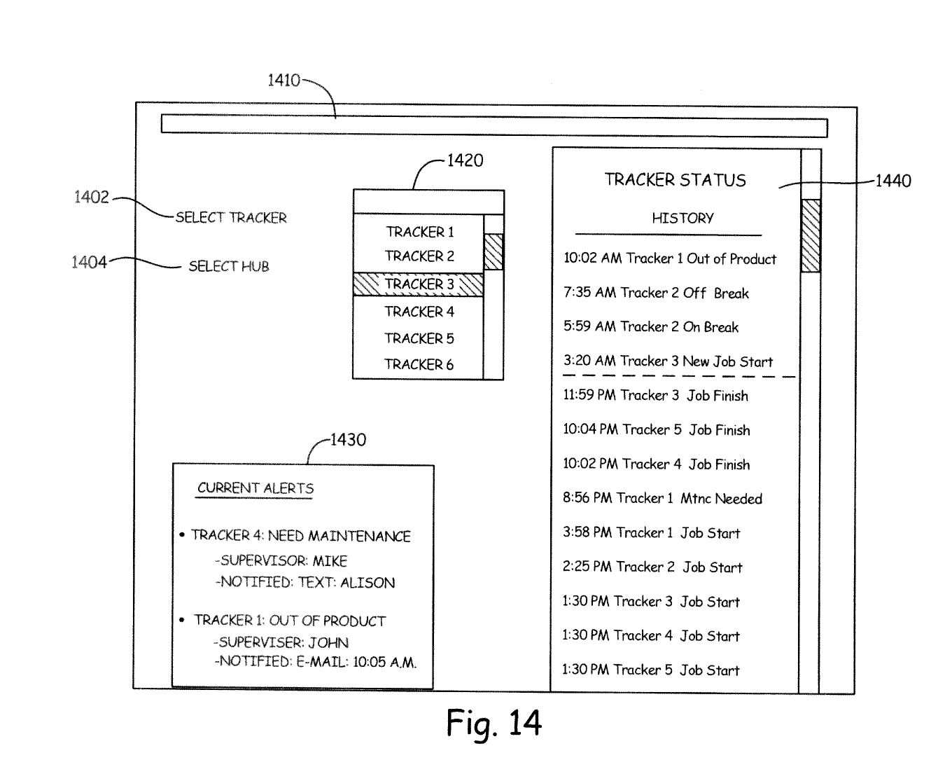

An exemplary website home display 1400 is shown in FIG. 14. The website home display 1400, in one embodiment, comprises a website address bar 1410, a dropdown menu 1420, a current alerts portion 1430, and a tracker status history 1440. In one embodiment, upon logging in, a user of the website 1330 encounters the website home display 1400. In order to access information about a specific tracker 130, in one embodiment, the user selects the dropdown menu 1420, and selects a tracker 130 to view more details about the production line 204 associated with the tracker 130. In one embodiment, however, instead of a dropdown menu 1420, the user selects a tracker through a pop-up window mechanism or, in a further embodiment, the plurality of trackers 130 are displayed in a portion of the website home display 1400 and the user merely needs to select one to view more details. In addition to the ability to view different trackers 130 via the select tracker mechanism 1402, the user can also select one of a plurality of hubs 120 to view through the select hub mechanism 1404. For client companies with a plurality of process environments 102, this allows a supervisor to narrow first by hub 120 through select hub mechanism 1404 and then by tracker 130 through select tracker mechanism 1402. In one embodiment, the select hub mechanism 1404 also brings up a dropdown menu displaying all available hubs for viewing.

In one embodiment, the website home display 1400 also includes a current alerts portion 1430. In one embodiment, the current alerts portion displays a series of alerts that are currently on-going for the trackers 130 and hubs 120 that are assigned to the user, e.g. that are associated with the log-in access or, for example, that have been designated by the user as important via a settings menu. As shown in FIG. 14, the current alerts portion 1430 may show, in addition to the trackers 130 currently displaying alerts, the type of alert being displayed, as well as the supervisor notified and the time the notification was sent. However, in another embodiment, the information shown in conjunction with an alert in the current alerts portion 1430 may be set by a user in a settings menu specific to the user, specific to a tracker 130 or specific to a hub 120, as desired by the user.

In one embodiment, the website home display 1400 further comprises a tracker status history 1440. As shown by FIG. 14, in one embodiment the tracker status history 1440 may comprise a history of all alerts for a specific process environment 102. In another embodiment, the tracker status history 1440 may only show alerts for a subset of trackers 130 indicated by the user as important, for example through a settings option of the website 1330. Additionally, in one embodiment, the tracker status history 1440 may show information other than alerts for a set of trackers. For example, as shown in FIG. 14, the tracker status history 1440 may also include information about jobs finishing, starting, when production lines 204 are on or off, for example as shown in lines 2 and 3, that “Tracker 2” went on break at 5:59 AM and off break at 7:35 AM. The ability to view a history of statuses and alerts allows a supervisor or manager to view the history of a specific tracker 130 and pin point when a particular problem occurred. In one embodiment, a user can further narrow down the tracker status history 1440 by selecting an individual tracker 130 through the dropdown menu 1420, wherein such a selection narrows both the current alerts portion 1430 and the tracker status history 1440 such that only the alerts and history for the selected tracker 130 are shown.

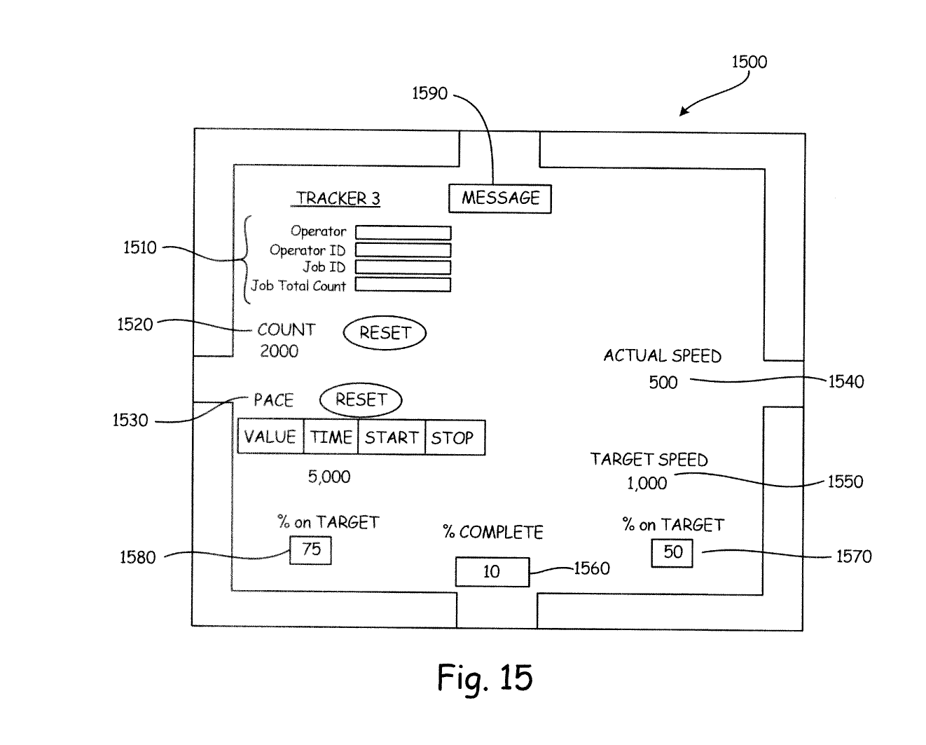

In one embodiment, selecting a tracker 130 through the dropdown menu 1420 brings the user to a website tracker view 1500, as shown in FIG. 15. In another embodiment, the user does not see this view until the user further indicates a desire to view the website tracker view 1500. For example, in one embodiment, the website tracker view 1500 is unavailable until after the user double clicks an item in the dropdown menu 1420.

The website tracker view 1500 is functionally similar, in one embodiment, to the tracker display 208, and includes count statistics 1520, pace statistics 1530, actual speed 1540, target speed 1550, a percent on target 1580 with respect to the count, and a percent on target 1570 with respect to the speed. Additionally, the website tracker view 1500 may also include, in one embodiment, alert indicators in the corner that mirror the settings on the tracker display with respect to indicators 502, 504, 506 and 508, in one embodiment, such that the view on the website tracker view is substantially the same view as on the tracker display 208. Additionally, in one embodiment the website tracker view 1500 also includes operator information 1510 which may include an operator name and ID, a job ID and a total count for the job. Additionally, the website tracker view 1500 also includes a messaging component 1590 that, in one embodiment, allows a user of the website 1330 to send messages to supervisors, managers, and operators on production lines 204 through the website tracker view 1500. The messaging component 1590 may, upon selection, open an e-mail component or, in another embodiment, may open a text box wherein a user can enter text to send to a supervisor, manager or operator. In one embodiment, the phone numbers and e-mail addresses corresponding to supervisors, managers and operators are saved in the user account management component such that a viewer of the website tracker view 1500 does not need to have the number or e-mail address of a desired recipient memorized or on hand. Additionally, the user of the website 1330 may also use the messaging component 1590 to respond to a comment left by an operator of the production line 204 through the tracker display 208.

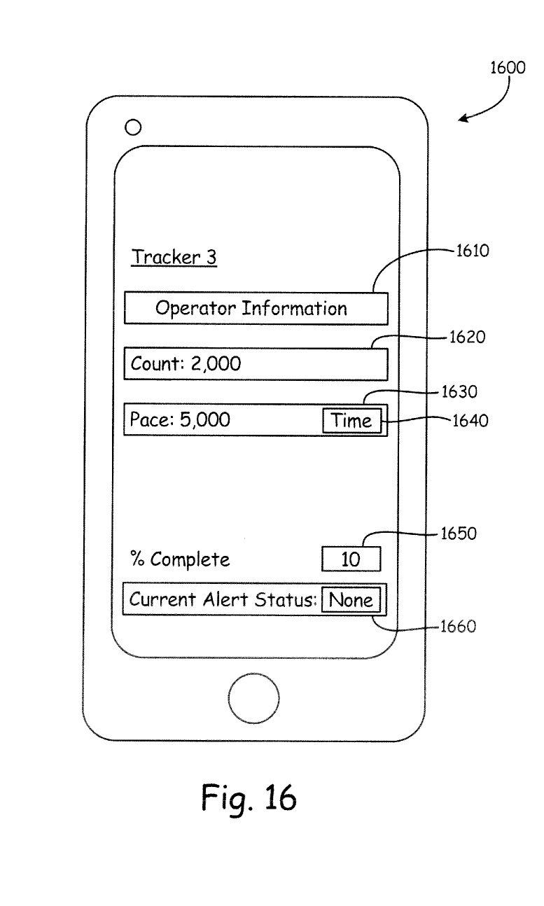

In one embodiment, the website 1330 is configured, through the mobile interface component 1314, to appear on a non-standard view, for example on a tablet or a smart phone, in a mobile format, such as mobile tracker view 1600. In one embodiment, the mobile tracker view 1600 is viewed on a mobile device 1610 as shown in FIG. 16. The mobile tracker view 1600 differs from the website tracker view in that it rearranges the information displayed such that it is more conveniently viewed by a user of the mobile device 1610. In one embodiment, a series of selectable icons are displayed to a user of the mobile device 1610, such that selecting a selectable icon will result in an expanded view showing further detail. For example, clicking on operator information icon 1610 may result in further information being displayed about the current operator of the selected tracker 130, in this case “Tracker 3” as selected as shown in FIG. 14.

The mobile tracker view 1600 may also include, in one embodiment, a count icon 1620 and a pace icon 1630, wherein clicking on either the count icon 1620 or the pace icon 1630 may result in either of these icons expanding to show more detailed information on the current count and/or the current pace. Additionally, clicking on the time/value icon 1640 may, in one embodiment, switch the pace statistics from a time measurement to a value measurement. Additionally, the percent complete icon 1650 may, in one embodiment, expand to show a percent complete with respect to count and pace in addition to the displayed percent complete with respect to the entire job.

Additionally, the mobile tracker view 1600 may also show any current alerts and/or the current status of the indicated tracker 130, in this case “Tracker 3.” For example, as shown in FIG. 16, there are no current alerts with respect to Tracker 3 currently. The user may be able to communicate with an operator of a production line 204 or a view of the hub display through a mobile messaging component (not shown). In one embodiment, the mobile messaging component may be configured such that it sends a text message or an e-mail using the capabilities of the mobile device 1610. In another embodiment, these communications means go through the website 1330, and not through the capabilities of the mobile device 1610.

While FIGS. 15 and 16 have shown views of statistics relating to an individual tracker 130, it is also to be understood that the website 1330 could also view similar statistics for a selected hub 120 on a website view or a mobile view, and communicate with an operator at a hub interface through a similar means as the messaging component 1590.

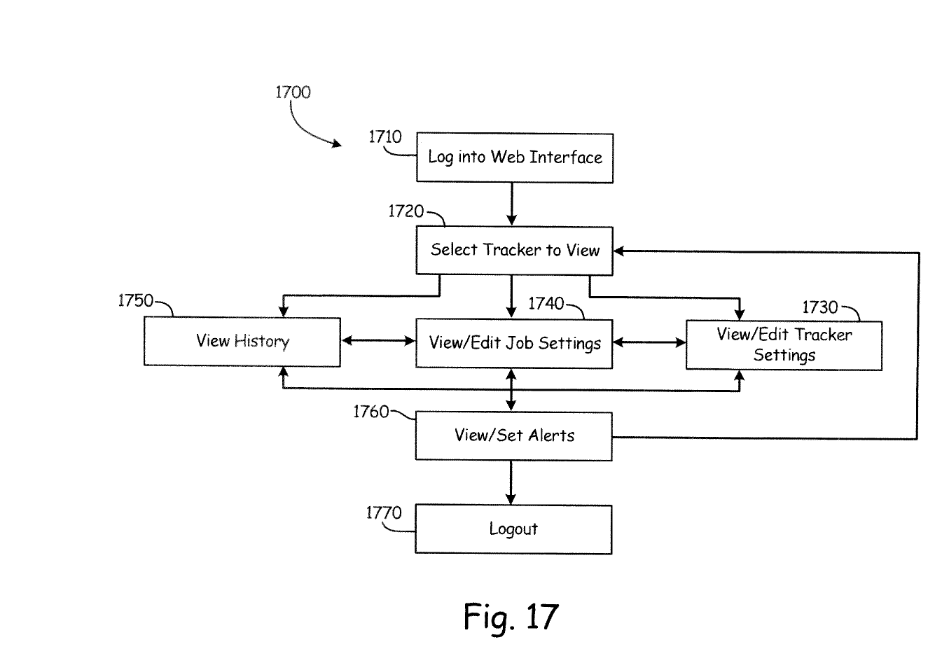

FIG. 17 is a flow diagram of a method, similar to the method of FIG. 10, for conveying information to supervisors through the website tracker view 1400, hub 120, the server 140, and the client device 114. FIG. 17 shows a method 1700, where the method 1700 modifies the settings of a particular tracker 130 using the website tracker view 1500 or the mobile tracker view 1600, in one embodiment. The rest of the method 1700 will be described with respect to the website tracker view 1500, however it is to be understood that the method 1700 could also be implemented on the mobile tracker view 1600. At block 1720, a user, for example a supervisor or manager, logs into the website tracker view 1500, for example by entering a username and password specific to the user. In one embodiment, a history is kept of those who view and/or make changes to the settings of a specific tracker 130 or hub 120 using the website tracker view 1500. Further, in one embodiment, an indication of a location of the user at the time of the viewing or changing is also stored in the history.

Additionally, if a supervisor or manager wishes to track a series of hubs 120 or trackers 130 that are not connected through the system 100. For example, a user may select to all trackers 130 associated with a first hub 120, but only three trackers 130 associated with a second hub 120. In one embodiment, through a settings menu, a user can select any subset of trackers 130 or hubs 120 to view on a website home view 1500 or mobile tracker view 1600. Additionally, the subset shown may be different on the website home view 1500 than the mobile tracker view 1600, in another embodiment. In a further embodiment, the user may designed a plurality of subsets to view, where each subset may be given a user-specified name and have its own subset-specific settings.

As part of block 1720, in one embodiment, the user can view all trackers 130 on the website tracker view 1500 before selecting a specific tracker 130 to view or edit. The user then, in one embodiment, selects a specific tracker 130 to view or edit, and has the option to view or edit current job settings in block 1740, view or edit the tracker 130 settings in block 1730, or view or edit the history for that tracker 1750.

In one embodiment, viewing or editing the job, as indicated in block 1740, may allow the user to, in one embodiment, view the current job statistics and information about the tracker 130 selected, for example information specific to the operator and/or the job as shown in FIG. 15. Alternatively, the user can view or edit settings specific to the selected tracker 130. This may include, in one embodiment, setting a multiplier for the tracker 130 specific to a job such that, when the sensor senses an item moving along the direction of production, it counts a multiple that reflects the actual number of units, for example when multiple units move along the production line at a time. In another embodiment, viewing or editing the job, as indicated in block 1740, may include altering the language viewed on the selected tracker 130.

Additionally, in one embodiment, the user may alternatively select, as shown in block 1730, to view or edit settings specific to the selected tracker 130. As described above, these settings may include, for example, changing the language specific to the selected tracker 130 during specific shifts or days of the week. Alternatively, the settings may include, for example, the specific alert sequences for the Andon lights on tracker display 208 for the selected tracker 130.

Further, the user may select to view or edit the history regarding that specific tracker 130 in block 1750. This may be of particular importance when a supervisor is determining when a particular problem took place. In this case, viewing or editing the history of the selected tracker 130 may include seeing a full history of all alerts that have been issued from that particular tracker 130 or viewing a limited history for example viewing only alerts that were sent from that particular tracker 130 during a particular shift or during a particular time period. Additionally, viewing or editing the history with regard to a specific tracker 130 may indicate to the supervisor which operators have been operating on the tracker 130 at different time periods during the last series of shifts.

After a user has completed one of blocks 1730, 1740, or 1750, the user may cycle between them and complete one, two or all three of those options. Then, when finished with these options, the user proceeds to block 1760, wherein the user has, in one embodiment, the opportunity to set alerts for the selected tracker 130. For example, the user may be selecting particular alerts specific to trackers 130 they are responsible during shifts they supervise. The user may, in one embodiment, set alert types as well. For example, alert types may be a text message or an e-mail notification based on a specific alert. For example, the user may want a text message for a low product indication, and an e-mail for a maintenance needed indication.

Once the user has completed setting alerts in block 1760 with respect to a selected tracker 130, the user will, in one embodiment as indicated by the arrow connecting block 1760 to 1720, repeat the process outlined in blocks 1720, 1730, 1740, 1750 and 1750 until the user has completed the desired editing for the plurality of trackers 130 that the user wants to edit. Then, in one embodiment, at block 1770 the user is presented with a log out screen wherein a user needs to log out to end the session with the hub 120. In one embodiment, any edits for a specific tracker 130 are made once the settings have been entered by a user. However, in an alternative embodiment, the settings are not entered for changed until the user has logged out of the hub system, or at least until the user has indicated a desire to save the edits made.

The system described above enables a method, in one embodiment, for collecting information is collected from a process system and making it available to supervisors through the website tracker view 1500 on a client device 114. As described above, the ability to make information available for and push alerts to supervisors who may or may not be on site is crucial for a process system. Without such a system, it is unclear why a particular alert is sounding, which production line 204 is indicated by the alert, or which supervisor needs to respond to the alert. For example, a maintenance indicated alert likely requires a different supervisor than a low product alert.

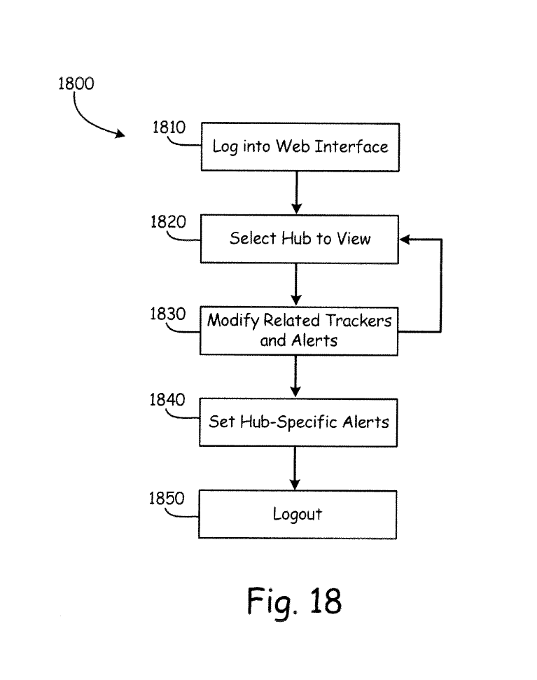

In one embodiment, the user, through the website home view 1400 can also set alerts specific to a single hub 120, as shown in FIG. 18. This method for hub modification 1800 allows, in one embodiment, a supervisor to edit settings for an entire process environment 102 for which the supervisor is responsible. In one embodiment this method is available, through the website home display 1400, by selecting a hub 120 through the dropdown menu 1420. In one embodiment, after logging into the website home display 1400, as shown in block 1810, the user then selects a hub 120 to view, as shown in block 1820. Once the specific hub 120 has been selected, the user then can modify settings on a hub-specific basis, as shown at block 1830 for example changing the language of all of the trackers 130 connected to the selected hub 120 such that, in changing from a day to a night shift, for example, the language of all of the trackers 130 changes from English to Spanish. This allows a supervisor to alter global settings for a single process environment 102 through a single interface, without having to set the same setting parameters to each of a plurality of trackers 130.

In another embodiment, the user can view all of the trackers 130 associated with a hub 120 and quickly edit settings for the each of the plurality of trackers 130 though a single interface, without having to individually select each of the trackers 130. Additionally, through this single interface embodied by block 1830, the user can set or alter alerts for each of the plurality of trackers 130 without having to go through the editing process for each individual tracker 130.

Further, after setting tracker-specific settings, the user can move on and also enter hub-specific settings and set hub-specific alerts at block 1840. For example, the user may want to specify that any tracker 130 reporting to a specific hub 120 have alerts sent, in one embodiment, by text message to the user and by e-mail to another supervisor. This method of hub-specific alert setting offers a convenient shortcut for changing global settings for a process environment 102 through the website home view 1400.

Throughout the disclosure certain variables such as count and pace have been emphasized. However, in other embodiments, other variables could be sensed by the sensors and displayed, stored and transmitted as described. Some other variables may be, in another embodiment, a volume that has passed a point in a production environment, a density, a current temperature, a current pressure, etc. These and other variables capable of being sensed by a sensor could be tracked and displayed by the system 100 in accordance with the systems and methods of the present disclosure.

Although the present invention has been described with reference to preferred embodiments, workers skilled in the art will recognize that changes may be made in form and detail without departing from the spirit and scope of the invention.

What is claimed is:

1. A method for providing a notification of a production line status, wherein the method comprises:
receiving a status indication of a production line from a tracker associated with the production line;
transmitting the status indication from the tracker to a server; and
transmitting the notification from the server to a client device, wherein the notification comprises the status indication.

2. The method of claim 1, wherein transmitting the status indication from the tracker to the server comprises transmitting the status indication from the tracker to a central hub, wherein the central hub then transmits the status indication to the server.

3. The method of claim 2, wherein the central hub is configured to receive and store status indications from a plurality of trackers.

4. The method of claim 1, wherein the client device is a computing device.

5. The method of claim 1, wherein the server is a remote server.

6. The method of claim 1, wherein transmitting the status indication further comprises storing the status indication, wherein storing the status indication comprises compiling a history of transmitted and stored status indications.

7. The method of claim 1, wherein the indication status comprises a current count of items that have moved along the production line during a job.

8. The method of claim 1, wherein the indication status comprises an alert.

9. The method of claim 8, wherein the alert comprises a low product notification.

10. The method of claim 8, wherein the alert comprises a maintenance needed notification.

11. A method for viewing a production line status in real-time on a display, the method comprising:
sensing with a sensor, the production line status;
transmitting the production line status to a display, wherein transmitting the production line status to the display further comprises:
transmitting a current count to the display when sensed by the sensor;
updating an existing count displayed on the display; and
storing the updated count.

12. The method of claim 11, and further wherein the production line status further comprises a current pace of the production line, and wherein transmitting the current count further comprises transmitting a current pace, and wherein updating the existing count displayed further comprises updating an existing pace, and wherein storing the updated count further comprises storing the updated pace.

13. The method of claim 11, wherein the sensor is a proximity sensor.

14. The method of claim 11, wherein the sensor is a photo sensor.

15. The method of claim 11, wherein the display also comprises an indication of a target count.

16. The method of claim 12, wherein the display also comprises an indication of a target pace.

17. The method of claim 11, wherein the display further comprises an indication of a job completion progress.

18. The method of claim 11, and further comprising:
further transmitting the production line status to a central hub;
storing the production line status within the central hub; and
displaying the production line status on a central hub display.

19. The method of claim 18, and further comprising:
further transmitting the production line status to a server;
storing the production line status within the server; and
transmitting the production line status to a computing device.

20. An update system for a process environment, the system comprising:
at least one sensor on an at least one production line in the process environment, wherein the sensor is configured to sense a current count and a current pace of the production line;
at least one production line display that receives and displays the current count and current pace from the sensor;
a central hub that receives the current count and the current pace from the at least one sensor;
a central hub display that displays the received current count and current pace from the central hub;
a server that receives and stores the current count and the current pace from the central hub; and
a web interface configured to receive the current count and the current pace from the server and display the current count and the current pace to a user.

21. A sensing system for a production line, the system comprising;
a sensor configured to sense a current count and a current pace of the production line;
a display component configured to receive and display the current count and the current pace of the production line in conjunction with a target count and a target pace of the production line, and wherein the current count and current pace are received by the display component from the sensor in a high-definition multimedia interface (HDMI) format; and
a processor that is a functional part of the sensing system and activated by the display component to facilitate display of the current count, the current pace, the target count and the target pace.
